(19) United States
(12) Patent Application Publication
(10) Pub. No.: US 2025/0067436 A1
(43) Pub. Date: Feb. 27, 2025

(54) AMMONIA COMBUSTOR

(71) Applicant: GE Infrastructure Technology LLC, Greenville, SC (US)

(72) Inventors: Rajani Kumar Akula, Bengaluru (IN); Michael John Hughes, State College, PA (US); Juergen Gerhard Hoffmann, Baden (CH)

(21) Appl. No.: 18/455,728

(22) Filed: Aug. 25, 2023

(51) Int. Cl. F23R 3/14; F23R 3/28; F23R 3/36

(52) U.S. Cl. CPC F23R 3/14; F23R 3/286; F23R 3/36; F05D 2240/35

(57) ABSTRACT

A combustor includes combustion liner that defines a combustion chamber that extends from a forward end to an aft end. The combustor further includes a fuel nozzle. The combustor further includes a first air injection apparatus that is disposed at a first air injection stage and that is fluidly coupled to an air supply. The first air injection apparatus includes a bluff body that has a side wall and a downstream plate. The first air injection apparatus is configured to introduce air at a downstream end into the combustion chamber at the first air injection stage. The combustor further includes a second air injection apparatus that is disposed at a second air injection stage and that is fluidly coupled to the air supply. The second air injection stage is positioned downstream of the fuel nozzle and the first air injection stage.

### FIELD

The present disclosure relates generally to a gas turbine combustor capable of efficient operation on alternative fuels, such as ammonia and/or hydrogen.

### BACKGROUND

Turbomachines are utilized in a variety of industries and applications for energy transfer purposes. For example, a gas turbine engine generally includes a compressor section, a combustion section, a turbine section, and an exhaust section. The compressor section progressively increases the pressure of a working fluid entering the gas turbine engine and supplies this compressed working fluid to the combustion section. The compressed working fluid and a fuel (e.g., natural gas for traditional systems) mix within the combustion section and burn in a combustion chamber to generate high pressure and high temperature combustion gases. The combustion gases flow from the combustion section into the turbine section where they expand to produce work. For example, expansion of the combustion gases in the turbine section may rotate a rotor shaft connected, e.g., to a generator to produce electricity. The combustion gases then exit the gas turbine via the exhaust section.

Traditional gas turbine engines include one or more combustors that burn a mixture of natural gas and air within the combustion chamber to generate the high pressure and temperature combustion gases. As a byproduct, nitrogen oxides (NOx) and other pollutants are created and expelled by the exhaust section. Regulatory requirements for low emissions from gas turbines are continually growing more stringent, and environmental agencies throughout the world are now requiring even lower rates of emissions of NOx and other pollutants from both new and existing gas turbines.

Alternative fuels can be used as a substitute for natural gas to reduce the production of NOx in the combustor. However, many alternative fuels have burning characteristics that make them unsuitable for use with traditional combustor operating methods. For example, such characteristics may include flame speed that is too slow/fast, flame temperature that is too hot/cold, and/or unwanted combustion byproducts.

Accordingly, an improved combustor capable of efficient operation on alternative fuels, such as ammonia (NH₃) and/or hydrogen, is desired and would be appreciated in the art.

### BRIEF DESCRIPTION

Aspects and advantages of the combustors and methods in accordance with the present disclosure will be set forth in part in the following description, or may be obvious from the description, or may be learned through practice of the technology.

In accordance with one embodiment, a combustor is provided. The combustor includes combustion liner that defines a combustion chamber that extends from a forward end to an aft end. The combustor further includes a fuel nozzle that is disposed at a forward end of the combustion chamber. The combustor further includes a first air injection apparatus that is disposed at a first air injection stage and that is fluidly coupled to an air supply. The first air injection stage is positioned downstream of the fuel nozzle. The first air injection apparatus includes a bluff body that has a side wall and a downstream plate. The first air injection apparatus is configured to introduce air at a downstream end into the combustion chamber at the first air injection stage. The combustor further includes a second air injection apparatus that is disposed at a second air injection stage and that is fluidly coupled to the air supply. The second air injection stage is positioned downstream of the fuel nozzle and the first air injection stage.

In accordance with another embodiment, a method of operating a combustor on alternative fuels is provided. The combustor includes a combustion liner that defines a combustion chamber that extends between a forward end and an aft end. The method includes providing, via a fuel nozzle, fuel and air to a forward end of the combustion chamber. The method further includes providing, via a first air injection apparatus, a first amount of air into the combustion chamber at a first air injection stage disposed downstream of the forward end. The method further includes providing, via a second air injection apparatus, a second amount of air into the combustion chamber at a second air injection stage. The second air injection stage is disposed downstream of the first air injection stage. The method further includes modulating a control valve to adjust the first amount of air and the second amount of air.

In accordance with yet another embodiment, a combustor is provided. The combustor includes a combustion liner defining a combustion chamber that extends from a forward end to an aft end. The combustor further includes a fuel nozzle disposed at a forward end of the combustion chamber. The combustor further includes a first air injection apparatus disposed at a first air injection stage and fluidly coupled to an air supply. The first air injection stage is positioned downstream of the fuel nozzle. The combustor further includes a second air injection apparatus that is disposed at a second air injection stage and that is fluidly coupled to the air supply. The second air injection stage is positioned downstream of the fuel nozzle and the first air injection stage. The combustor further includes a control valve that is fluidly coupled to the first air injection apparatus, the air second air injection apparatus, and the air supply. The control valve is configured to modulate an amount of air provided to the combustion chamber from the air supply at the first air injection stage and the second air injection stage.

These and other features, aspects and advantages of the present combustors and methods will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present combustors and methods, including the best mode of making and using the present systems and methods, directed to one of ordinary skill in the art, is set forth in the specification, which makes reference to the appended figures, in which:

FIG. 1 is a schematic illustration of a turbomachine in accordance with embodiments of the present disclosure;

FIG. 2 illustrates a combustor in accordance with embodiments of the present disclosure, as may be used with the turbomachine of FIG. 1;

FIG. 3 schematically illustrates a combustor in accordance with embodiments of the present disclosure, as may be used with the turbomachine of FIG. 1;

FIG. 4 schematically illustrates a combustor in accordance with embodiments of the present disclosure, as may be used with the turbomachine of FIG. 1;

FIG. 5 illustrates a cross-sectional view of the combustor shown in FIG. 3 from along the line 5-5 in accordance with embodiments of the present disclosure;

FIG. 6 illustrates a cross-sectional view of the combustor shown in FIG. 4 from along the line 6-6 in accordance with embodiments of the present disclosure;

FIG. 7 is a flow diagram of a method of operating a combustor on alternative fuels in accordance with embodiments of the present disclosure; and

FIG. 8 provides a block diagram of a computing system for implementing one or more aspects of the present disclosure according to example embodiments of the present disclosure.

### DETAILED DESCRIPTION

Reference now will be made in detail to embodiments of the present combustors and methods, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

The term “fluid” may be a gas or a liquid. The term “fluid communication” means that a fluid is capable of making the connection between the areas specified.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component, and the term “circumferentially” refers to the relative direction that extends around the axial centerline of a particular component.

Terms of approximation, such as “about,” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values, and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “and/or” refers to an inclusive selection and not to an exclusive selection. For example, a condition A and/or B is satisfied by any one of the following: A is true (or present) and B is false (or not present), A is false (or not present) and B is true (or present), and both A and B are true (or present).

Here and throughout the specification and claims, where range limitations are combinable and interchangeable, such ranges are identified and include all the sub-ranges contained therein unless context or language indicates otherwise. For example, all ranges disclosed herein are inclusive of the endpoints, and the endpoints are independently combinable with each other.

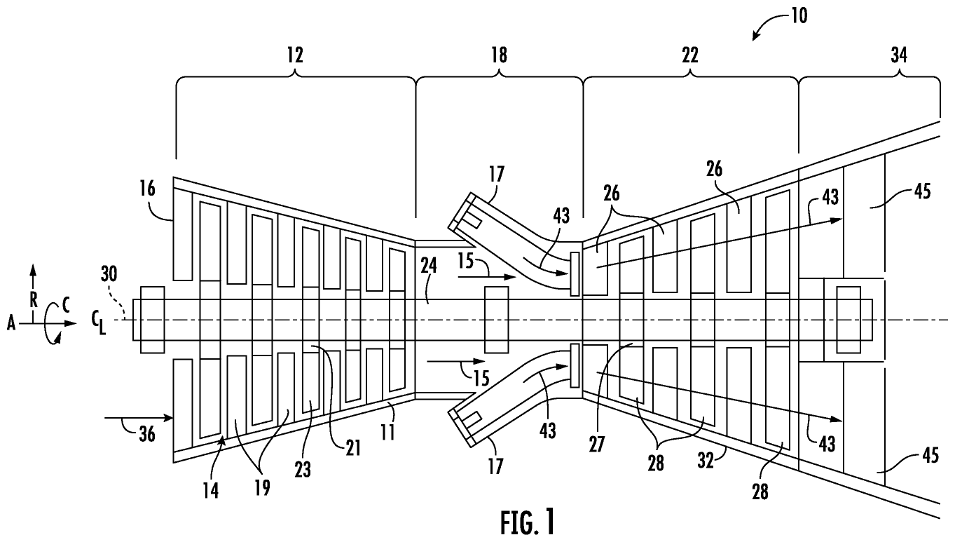

Referring now to the drawings, FIG. 1 illustrates a schematic diagram of one embodiment of a turbomachine, which in the illustrated embodiment is a gas turbine engine 10. Although an industrial or land-based gas turbine is shown and described herein, the present disclosure is not limited to an industrial or land-based gas turbine engine, unless otherwise specified in the claims. For example, the invention as described herein may be used in any type of turbomachine including, but not limited to, a steam turbine, an aircraft gas turbine, or a marine gas turbine.

As shown in FIG. 1, the gas turbine 10 generally includes a compressor section 12. The compressor section 12 includes a compressor 14. The compressor includes an inlet 16 that is disposed at an upstream end of the gas turbine engine 10. The gas turbine engine 10 further includes a combustion section 18 having one or more combustors 17 disposed downstream from the compressor section 12. The gas turbine engine 10 further includes a turbine section 22 (i.e., an expansion turbine) that is downstream from the combustion section 18. A shaft 24 extends generally axially through the gas turbine engine 10.

The compressor section 12 may generally include a plurality of rotor disks 21 and a plurality of rotor blades 23 extending radially outwardly from and connected to each rotor disk 21. Each rotor disk 21 in turn may be coupled to or form a portion of the shaft 24 that extends through the compressor section 12. The rotor blades 23 of the compressor section 12 may include turbomachine airfoils that define an airfoil shape (e.g., having a leading edge, a trailing edge, and side walls extending between the leading edge and the trailing edge). Additionally, in many embodiments, the compressor section 12 may include stator vanes 19 disposed between the rotor blades 23. The stator vanes 19 may extend from, and couple to, a compressor casing 11.

The turbine section 22 may generally include a plurality of rotor disks 27 and a plurality of rotor blades 28 extending radially outwardly from and being interconnected to each rotor disk 27. Each rotor disk 27 in turn may be coupled to or form a portion of the shaft 24 that extends through the turbine section 22. The turbine section 22 further includes an outer casing 32 that circumferentially surrounds the turbine portion of the shaft 24 and the rotor blades 28. The turbine section 22 may include stator vanes 26 extending radially inward from the outer casing 32. The rotor blades 28 and stator vanes 26 may be arranged in alternating stages along an axial centerline 30 of gas turbine 10. Both the rotor blades 28 and the stator vanes 26 may include turbomachine airfoils that define an airfoil shape (e.g., having a leading edge, a trailing edge, and side walls extending between the leading edge and the trailing edge).

In operation, ambient air 36 or other working fluid is drawn into the inlet 16 of the compressor 14 and is progressively compressed to provide a compressed air 15 to the combustion section 18. The compressed air 15 flows into the combustion section 18 and is mixed with fuel to form a combustible mixture. The combustible mixture is burned within a combustion chamber of the combustor(s) 17, thereby generating combustion gases 43 that flow from the combustion chamber(s) into the turbine section 22. Energy (kinetic and/or thermal) is transferred from the combustion gases 43 to the rotor blades 28, causing the shaft 24 to rotate and produce mechanical work. The spent combustion gases 43 (also called “exhaust gases”) exit the turbine section 22 and flow through the exhaust diffuser 34 across a plurality of struts or main airfoils 45 that are disposed within the exhaust diffuser 34.

The gas turbine engine 10 may define a cylindrical coordinate system having an axial direction A extending along the axial centerline 30, a radial direction R perpendicular to the axial centerline 30, and a circumferential direction C extending around the axial centerline 30.

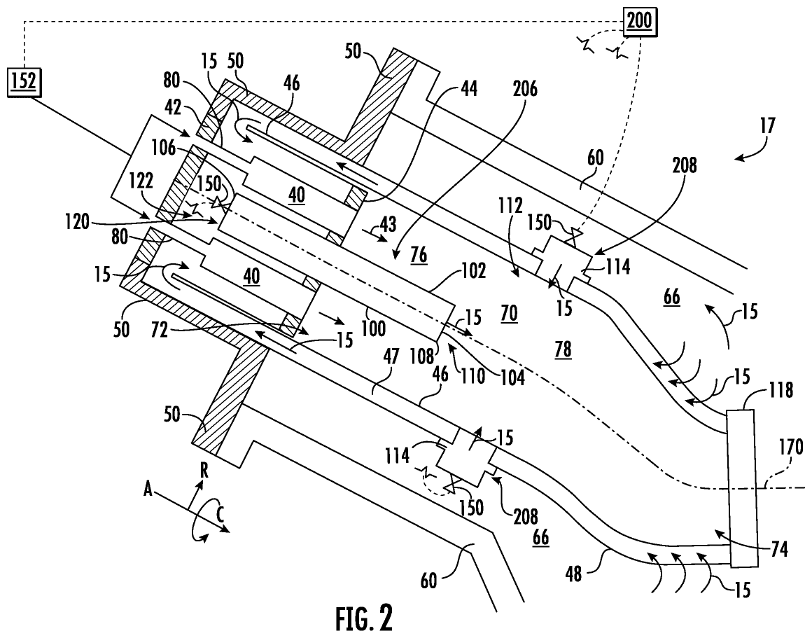

FIG. 2 is a schematic representation of a combustor 17, as may be included in a can annular combustion system for the gas turbine engine 10. In a can annular combustion system, a plurality of combustors 17 (e.g., 8, 10, 12, 14, 16, or more) are positioned in an annular array about the shaft 24 that connects the compressor section 12 to the turbine section 22.

As shown in FIG. 2, the combustor 17 may define a cylindrical coordinate system having an axial direction A that extends along an axial centerline 170. The combustor may also define a circumferential direction C which extends around the axial direction A and the axial centerline 170. The combustor 17 may further define a radial direction R perpendicular to the axial direction A and the axial centerline 170.

As shown in FIG. 2, the combustor 17 includes a combustion liner 46 that defines a combustion chamber 70. The combustion liner 46 may be positioned within (i.e., circumferentially surrounded by) an outer sleeve 48, such that an annulus 47 is formed therebetween. That is, the outer sleeve 48 may be spaced radially outward of the combustion liner 46 to define the annulus 47 through which compressed air 15 flows to a head end of the combustor 17. For example, compressed air 15 may enter the annulus 47 through the outer sleeve 48 (e.g., proximate the aft frame 118) and travel towards an end cover 42, such that the compressed air 15 within the annulus 47 flows opposite the direction of combustion gases within the combustion liner 46. Heat is transferred convectively from the combustion liner 46 to the compressed air 15, thus cooling the combustion liner 46 and warming the compressed air 15.

In some embodiments, the outer sleeve 48 may include a flow sleeve and an impingement sleeve coupled to one another. The flow sleeve may be disposed at the forward end, and the impingement sleeve may be disposed at the aft end. Alternately, the outer sleeve 48 may have a unified body (or “unisleeve”) construction, in which the flow sleeve and the impingement sleeve are integrated with one another in the axial direction. As before, any discussion of the outer sleeve 48 herein is intended to encompass both conventional combustion systems having a separate flow sleeve and impingement sleeve and combustion systems having a unisleeve outer sleeve.

The combustion liner 46 may contain and convey combustion gases to the turbine section 22. The combustion liner 46 defines the combustion chamber 70 within which combustion occurs. As shown in FIG. 2, the combustion liner 46 may extend between fuel nozzles 40 and an aft frame 118. The combustion liner 46 may have a cylindrical liner portion and a tapered transition portion that is separate from the cylindrical liner portion, as in many conventional combustion systems. Alternately, the combustion liner 46 may have a unified body (or “unibody”) construction, in which the cylindrical portion and the tapered portion are integrated with one another. Thus, any discussion of the combustion liner 46 herein is intended to encompass both conventional combustion systems having a separate liner and transition piece and those combustion systems having a unibody liner. Moreover, the present disclosure is equally applicable to those combustion systems in which the transition piece and the stage one nozzle of the turbine section 22 are integrated into a single unit, sometimes referred to as a “transition nozzle” or an “integrated exit piece.”

A forward casing 50 and the end cover 42 of the combustor 17 define the head end air plenum 122, which includes the one or more fuel nozzles 40. The forward casing 50 may be fluidly and mechanically connected to a compressor discharge casing 60, which defines a high pressure plenum 66 around the combustion liner 46 and the outer sleeve 48. The fuel nozzles 40 may be any type of fuel nozzle, such as swirler nozzles (often referred to as “swozzles”) or bundled tube fuel nozzles (often referred to as “micromixers”), both of which premix fuel and air prior to introduction into the combustion chamber 70. The fuel nozzles 40 may be positioned within the head end air plenum 122 defined at least partially by the forward casing 50. In many embodiments, the fuel nozzles 40 may extend from the end cover 42. For example, each fuel nozzle 40 may be coupled to an aft surface of the end cover 42 via a flange (not shown). As shown in FIG. 2, the at least one fuel nozzle 40 may be partially surrounded by the combustion liner 46. The aft, or downstream ends, of the fuel nozzles 40 extend through a cap plate 44 that defines the upstream end of the combustion chamber 70 (and a downstream end of the head end air plenum 122).

The fuel nozzles 40 may be positioned at the forward end of the combustor 17, and fuel may be directed through fuel supply conduits 80, which extend through an end cover 42, and into the fuel nozzles 40. The fuel nozzles 40 convey the fuel and compressed air 15 into the combustion chamber 70, where combustion occurs. In some embodiments, the fuel and compressed air 15 are combined as a mixture prior to reaching the combustion chamber 70. In other embodiments, the fuel and compressed air 15 are provided separately to the combustion chamber 70 by the fuel nozzles 40 (e.g., not as a mixture). The fuel nozzles 40 may be in fluid communication with a fuel supply system 152 configured to supply one or more fuels to the fuel nozzles 40. In many embodiments, the fuel supplied to the fuel nozzles 40 may be a fuel mixture containing ammonia, hydrogen, and/or natural gas (such as methane). In other embodiments, the fuel supplied to the fuel nozzles may be only one of ammonia, hydrogen, and/or natural gas (such as methane).

As shown in FIG. 2, the combustor 17 may advantageously include a first air injection stage 110 and a second air injection stage 112, which may be axially spaced apart from one another. The first air injection stage 110 may be disposed downstream of the outlets of the fuel nozzles 40, and the second air injection stage 112 may be downstream of the first air injection stage 110 and upstream of the aft frame 118. As discussed below, the first air injection stage 110 may be provided by a first air injection apparatus 206, which in exemplary embodiments may be a bluff body 100. The second air injection stage 112 may be provided by a second air injection apparatus 208, which in exemplary embodiments may be an air injector 114 disposed downstream of the bluff body 100. The multiple air injection stages advantageously maintain the desired equivalence ratio of fuel/air (especially when operating on alternative fuel, such as ammonia and/or hydrogen) at each axial location within the combustion chamber 70.

The amount of air introduced into the combustion chamber 70 at the first air injection stage 110 and the second air injection stage 112 may be adjusted to maintain a desired equivalence ratio. the As used herein, “rich mixture” may refer to a fuel/air or fuel/oxidant mixture having an equivalence ratio (Φ) greater than 1, and “lean mixture” may refer to a fuel/air mixture having an equivalence ratio (Φ) less than 1. A rich mixture may have insufficient oxidants (e.g., air) to result in complete combustion, while a lean mixture may have excess oxidants (e.g., air). As used herein, the equivalence ratio (Φ) is defined as the ratio of the fuel-to-air ratio (or actual ratio) and the stoichiometric fuel-to-air ratio (or theoretical ratio). Mathematically, the equivalence ratio may be calculated as follows:

$$Φ = \frac{\frac{{m}_{fuel}}{{m}_{air}}}{{( \frac{{m}_{fuel}}{{m}_{air}} )}_{st}}$$

where m represents the mass, and the suffix st stands for stoichiometric conditions.

As shown in FIG. 2, the bluff body 100 may extend between, and be in fluid communication with, the head end air plenum 122 and the combustion chamber 70. The bluff body 100 may extend along the axial centerline 170 of the combustor 17 from a forward end 106 disposed in the head end air plenum 122 to an aft end 108 disposed in the combustion chamber 70 downstream of the fuel nozzles 40. The bluff body 100 may define an inlet at the forward end 106 and an outlet at the aft end 108, such that the bluff body 100 receives compressed air 15 from the head end air plenum 122 at the forward end 106 and conveys the compressed air 15 to the combustion chamber 70 at the aft end 108. The bluff body 100 may include a first portion disposed in the head end air plenum 122 and a second portion disposed in the combustion chamber 70.

The bluff body 100 may extend along the axial centerline 170 of the combustor 17 from the forward end 106 (which is disposed in the head end air plenum 122), through the cap plate 44, to the aft end 108. The bluff body 100 may include a side wall 102 wall and a downstream plate 104. In many embodiments, the side wall 102 may be annular and may surround the axial centerline 170 of the combustor 17. For example, the bluff body 100 may have a generally circular cross sectional shape in many embodiments. The side wall 102 of the bluff body 100 may be coupled to the cap plate 44. The bluff body 100 may be generally shaped as a hollow cylinder (although other shapes may be possible).

In some embodiments, the side wall 102 may be solid, such that no fluid (such as air or combustion gases) passes therethrough, and the downstream plate 104 may be perforated (i.e., may define a plurality of injection apertures or outlets) such that the bluff body 100 provides compressed air to the combustion chamber 70 in a generally axial direction. Alternately, the downstream end of the side wall 102 may include perforations that direct air outwardly from the bluff body 100 toward the liner 46, and the downstream plate 104 may or may not include perforations.

In addition to air injection, the bluff body 100 may provide for bluff body stabilization within the combustion chamber 70. Bluff body stabilization occurs when the fuel/air exiting the fuel nozzles 40 combusts and passes around the bluff body 100. The combustion gases and un-combusted fuel/air creates a wake or recirculation zone aft the bluff body 100, which increases mixing and thereby facilitates the formation of a stable flame.

The air injectors 114 may be disposed downstream (or aft) of the downstream plate 104 of the bluff body 100 such that an axial gap is disposed therebetween. The air injectors 114 may mount to the outer sleeve 48 and/or the combustion liner 46. The air injectors 114 may extend radially from a first end within the high pressure plenum 66, through the outer sleeve 48, the annulus 47, and the combustion liner 46 to a second end. The second end may be disposed at the combustion liner 46 (e.g., radially flush or aligned therewith such that the air injector 114 does not extend into the combustion chamber 70).

Such a combustion system having axially separated air injection zones may be referred to as an “axial air staging” (AAS) system. The air injectors 114 may be circumferentially spaced apart from one another on the outer sleeve 48 (e.g., equally spaced apart in some embodiments). The combustor 17 may include any number of fuel injection assemblies (e.g., 1, 2, 3, or upwards of 10). In other embodiments, the second air injection stage 112 may be in the implemented by dilution holes in the combustion liner 46, such that the combustion chamber 70 receives air from the annulus 47 rather than directly from the high pressure plenum 66.

In many embodiments, the combustor 17 may include control valve(s) 150 disposed in fluid communication with the bluff body 100 and/or the air injector(s) 114. The control valve(s) 150 may regulate the amount of air permitted to flow through the bluff body 100 and/or the air injector(s) 114, thereby regulating the equivalence ratio within the combustion chamber 70 at each axial stage. In other words, the amount of air injected at the first air injection stage 110 and the second air injection stage 112 may be adjusted (or modified) by modulating (or actuating) the control valve(s) 150.

The control valve(s) 150 may be actuatable between a fully open position, in which the flow of air therethrough is unrestricted, and a fully closed position, in which the flow of air therethrough is fully restricted. In addition, the control valve(s) may be actuatable to any position between the fully open and fully closed positions, such as anywhere between 0% and 100% restricted. In some embodiments, the air supplied to the bluff body 100 and the air injector(s) 114 are coordinately adjusted to achieve the desired equivalence ratio within the combustion chamber 70.

In many embodiments, a controller 200 may be operably connected to, and in communication with, the fuel supply system 152 and the control valve(s) 150. The controller 200 may be configured to send control signals to the fuel supply system 152 and/or the control valve(s) 150 to adjust their operation. For example, the controller 200 may selectively adjust the amount of fuel, fuel type, fuel mixture, etc. provided by the fuel supply system 152 to the fuel nozzles 40. Additionally, the controller 200 may selectively actuate or modulate the control valve(s) to adjust an amount of air permitted therethrough.

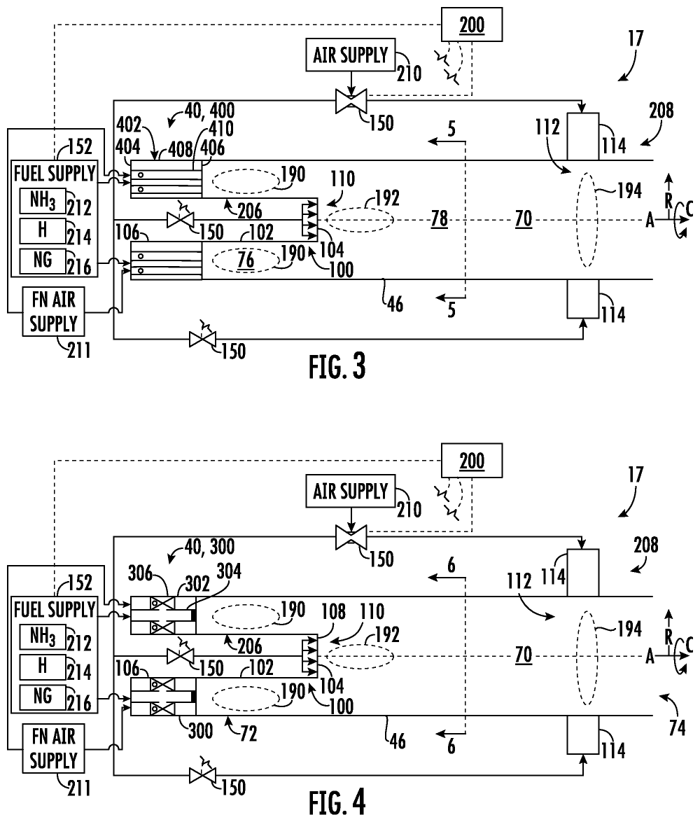

Referring now to FIGS. 3 and 4, a combustor 17 is illustrated in accordance with embodiments of the present disclosure. As shown, the combustor 17 may include a combustion liner 46 that extends along an axial centerline 170 and defines a combustion chamber 70. The combustion chamber 70 may extend between a forward end 72 and an aft end 74.

A fuel nozzle 40 may be disposed the forward end 72 of the combustor 17. The fuel nozzle 40 may be one of a plurality of fuel nozzles 40 arranged at the forward end 72. In some embodiments, the fuel nozzles 40 may be swirler nozzles 300, which are often referred to as “swozzles” (FIG. 3). In some embodiments, the fuel nozzles 40 may be bundled tube fuel nozzles 400, which are often referred to as a “micromixer” (FIG. 4).

The fuel nozzles 40 may be fluidly coupled to a fuel supply system 152. The fuel supply system 152 may supply fuel to the fuel nozzles 40, and the fuel supply system 152 may be configured to selectively supply different fuel types. amounts, mixtures, etc. to the fuel nozzles 40. In many embodiments, the fuel supply system 152 may include an ammonia supply 212 (such as a liquid ammonia supply and/or gaseous ammonia supply), a hydrogen supply 214 (such as a liquid hydrogen supply and/or gaseous hydrogen supply), and/or a natural gas supply 216 (such as a methane supply or other natural gas). In some implementations, the fuel supply system 152 may provide only one type of fuel to the fuel nozzles 40 at a time, such as only ammonia, only hydrogen, and/or only natural gas. In other implementations, the fuel supply system 152 may provide a fuel mixture including any combination of ammonia, hydrogen, and/or natural gas to the fuel nozzles 40.

In exemplary implementations, the combustor 17 may include a first air injection apparatus 206 disposed at a first air injection stage 110 and fluidly coupled to an air supply 210. Additionally, the combustor may include a second air injection apparatus 208 disposed at a second air injection stage 112 and fluidly coupled to the air supply 210. The air supply 210 may be the high pressure plenum 66, the annulus 47, or the head end air plenum 122 shown and described above with reference to FIG. 2, or the air supply 210 may be an auxiliary air supply.

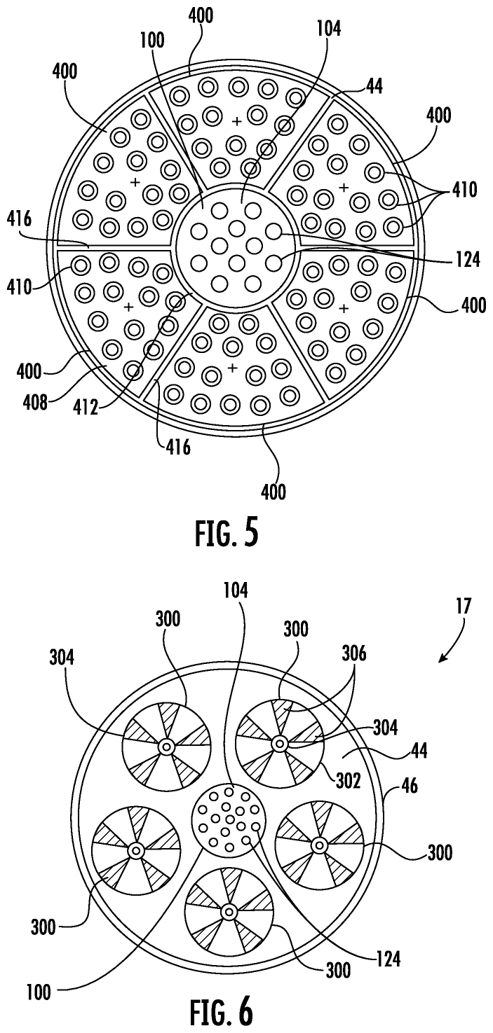

In exemplary embodiments, the first air injection apparatus 206 may be a bluff body 100. The bluff body 100 may extend along the axial centerline 170 of the combustor 17 from a forward end 106 to an aft end 108 disposed at the first air injection stage 110 within the combustion chamber 70 downstream of the fuel nozzles 40 and upstream of the second air injection apparatus 208. The bluff body 100 may extend axially within the combustion chamber from the forward end 72 to about 50% of a total length of the combustion chamber 70 (e.g., the axial length from forward end 72 to aft end 74), or such as about 40% of the total length, or such as about 30% of the total length, or such as about 20% of the total length, or such as about 10% of the total length. The bluff body 100 may define an inlet 120 at the forward end 106 and an outlet 124 (FIGS. 5 and 6) at the aft end 108, such that the bluff body 100 receives air from the air supply 210 and provides the air to the combustion chamber 70 at the first air injection stage 110.

As discussed above, the bluff body 100 may include an side wall 102 and a downstream plate 104. The side wall 102 may be solid, such that no fluid (such as air or combustion gases) passes therethrough. The downstream plate 104 may be perforated (i.e., may define a plurality of injection apertures or outlets 124) such that the bluff body 100 provides air to the combustion chamber 70. The side wall 102 may extend generally axially and may surround the axial centerline 170. The downstream plate 104 may extend generally radially (generally perpendicularly to the side wall) and couple to the side wall 102. The downstream plate 104 may introduce air into the combustion chamber 70 at the first air injection stage 110 at a downstream end of the bluff body 100 or at an acute angle relative to the axial centerline 170. For example, the downstream plate 104 may define the outlets 124, which may be oriented generally axially such that air exiting the bluff body 100 flows in the axial direction A. Alternately, the outlets 124 may be provided with an angular orientation to direct flow from the downstream plate 104 at an angle. In other embodiments (not shown), the bluff body 100 (such as the side wall 102) may define outlets oriented generally radially such that air exiting the bluff body 100 flows in the radial direction R.

In other embodiments (not shown), the downstream end of the side wall 102 may include the perforations 124, instead of or in addition to the perforations 124 formed in the downstream plate 104. Air flowing from such perforations may be delivered in a radial direction (perpendicularly to the axial centerline 170) or at an acute angle relative to the axial centerline 170.

The fuel nozzles 40 may be disposed radially outwardly of the bluff body 100. In many embodiments, as shown in FIGS. 5 and 6, the fuel nozzles 40 may circumferentially surround the bluff body 100. Additionally, the bluff body 100 (e.g., the side wall 102 and the downstream plate 104) may partially define the combustion chamber 70, such that the fuel/air stream from the fuel nozzles 40 travels along the side wall 102 of the bluff body 100, which advantageously creates a flow recirculation zone aft of the downstream plate 104 that promotes mixing and efficient combustion. In this way, the combustion chamber 70 may include an annular portion 76 defined between the combustion liner 46 and the bluff body 100 (as shown in FIGS. 3 and 4). Particularly, the annular portion 76 may be defined radially between the combustion liner 46 and the side wall 102, and the annular portion 76 may be defined axially between the outlets of the fuel nozzles 40 and the downstream plate 104. The air traveling through the bluff body 100 may advantageously be preheated by the combustion gases traveling through the combustion chamber 70 along the outer surface of the bluff body 100.

The combustion chamber 70 may further include a main portion 78 extending aft of the annular portion 76 to the aft end 108. Particularly, the main portion 78 may be defined entirely by the combustion liner 46 and may extend axially between the downstream plate 104 and the aft end 74 of the combustion chamber 70 (i.e., aft frame 118).

In exemplary embodiments, a second air injection apparatus 208 may be disposed at the second air injection stage 112 and may be fluidly coupled to the air supply 210. The second air injection stage 112 may be positioned downstream (or aft) of the fuel nozzles 40 and the first air injection stage 110. For example, the second air injection apparatus 208 may be disposed aft of the downstream plate 104 such that an axial gap is defined between the downstream plate 104 and the second air injection apparatus 208. In many embodiments, the second air injection apparatus 208 is an air injector 114 coupled to the combustion liner 46 and configured to introduce air radially into the combustion chamber 70 at the second air injection stage 112. For example, the air injector 114 may include a main body that defines a channel through which air may flow from the air supply 210 into the combustion chamber 70. The air injector 114 may be mounted to the combustion liner 46 such that the opening in the air injector 114 is oriented along the radial direction R, thereby injecting the air radially into the combustion chamber 70.

In many embodiments, the combustor 17 further includes a control valve 150 that is fluidly coupled to the first air injection apparatus 206, the second air injection apparatus 208, and the air supply 210. The control valve 150 may modulate an amount of air provided to the combustion chamber 70 from the air supply 210 at the first air injection stage 110 and the second air injection stage 112. In some embodiments, as shown in FIGS. 3 and 4, the control valve 150 may be a single control valve that controls the amount of air provided to the first air injection apparatus 206 and air second air injection apparatus 208.

In other embodiments, as shown in FIG. 2, the combustor may include a plurality of control valves 150 (e.g., a control valve 150 coupled to each of the air injectors 114 and a control valve 150 coupled to the bluff body 100). In such embodiments, the multiple control valves 150 may operate coordinately such that the control valves 150 collectively modulate an amount of air provided to the combustor 17 at the first air injection stage 110 and the second air injection stage 112.

As shown in FIGS. 3 and 4, in many embodiments, the combustor 17 may further include a fuel nozzle (FN) air supply 211, which may be the same or different than the air supply 210. The FN air supply 211 may be fluidly coupled to the fuel nozzles 40, such that the fuel nozzles 40 receive air from the FN air supply 211. The FN air supply 211 may freely supply air to the fuel nozzles 40, such that the air flowing into the fuel nozzles 40 is not regulated by the control valves 150 discussed above.

Referring particularly to the combustor 17 shown in FIG. 3, in some embodiments, the fuel nozzles 40 may each be a swirler nozzle 300 (or “swozzle”). The swirler nozzle 300 may have an outer tube 302, a center body 304 radially spaced apart from the outer tube 302, and vanes 306 extending between the center body 304 and the outer tube 302. In many implementations, an annulus defined between the outer tube 302 and the center body 304 may receive air, and the center body 304 may receive fuel. The fuel may be provided to the vanes 306 and injected into the annulus downstream of the vanes 306, such that the fuel mixes with the air and is injected into the combustion chamber 70.

In other embodiments, as shown in FIG. 4, the fuel nozzles 40 may each be a bundled tube fuel nozzle 400. The bundled tube fuel nozzle 400 may define a fuel plenum 402 with (e.g., collectively with) a forward plate 404, an aft plate 406, and an annular body 408 that extends (e.g., axially) between the forward plate 404 and the aft plate 406. A plurality of tubes 410 may extend from the forward plate 404, through the fuel plenum 402, and to the aft plate 406. The plurality of tubes 410 may each define an inlet (e.g., for air) at the forward plate 404 and an outlet (e.g., for air/fuel) at the aft plate 406. Each of the tubes 410 may define a fuel injection port between the inlet and the outlet that fluidly couples the tube 410 to the fuel plenum 402.

In many embodiments, a controller 200 may be operably connected to, and in communication with, the fuel supply system 152 and the control valve 150. The controller 200 may be configured to send control signals to the fuel supply system 152 and/or the control valve 150 to adjust their operation. For example, the controller 200 may selectively adjust the amount of fuel, fuel type, fuel mixture, etc. provided by the fuel supply system 152 to the fuel nozzles 40. Additionally, the controller 200 may selectively actuate or modulate the control valve 150 to adjust an amount of air provided to the first air injection apparatus 206 and the second air injection apparatus 208.

As shown in FIGS. 3 and 4, the combustion chamber 70 may define an ammonia-hydrogen combustion zone 190, in which a mixture of ammonia and hydrogen are injected and burned. The ammonia-hydrogen combustion zone 190 may extend between the outlets of the fuel nozzles 40 and the first air injection stage 110. The ammonia-hydrogen combustion zone 190 may be ammonia-rich, such that the fuel injected into the ammonia-hydrogen combustion zone 190 by the fuel nozzles 40 contains greater than about 50% ammonia, or such as greater than about 90% ammonia, with a remainder being another fuel (such as hydrogen). The ammonia-hydrogen combustion zone 190 may have a rich equivalence ratio or a lean equivalence ratio, but in exemplary embodiments, the ammonia hydrogen combustion zone 190 may have a rich equivalence ratio, such that the equivalence ratio is greater than 1.

Additionally, the combustion chamber 70 may define a first ammonia combustion zone 192 aft of the first air injection stage 110. The first ammonia combustion zone 192 may extend between the first air injection stage and the second air injection stage 112. In many implementations, most of the hydrogen may burn in the ammonia-hydrogen combustion zone 190 prior to the ammonia combustion zone 192, leaving mostly unburned ammonia. The first air injection stage may facilitate further burning of the ammonia in the first ammonia combustion zone 192. Further, the combustion chamber may define a second ammonia combustion zone 194 aft of the second air injection stage 112. The remainder of the unburned ammonia may burn in the second ammonia combustion zone 192. In some implementations, the first ammonia combustion zone 192 may have a rich equivalence ratio and the second ammonia combustion zone 194 may have a lean equivalence ratio.

Referring now to FIG. 5, a cross-sectional view of the combustor 17 shown in FIG. 3 from along the line 5-5 is illustrated in accordance with embodiments of the present disclosure. As shown, the combustor 17 may include a plurality of bundled tube fuel nozzles 400 that are positioned about, and that collectively surround, the bluff body 100. As discussed above, each of the bundled tube fuel nozzles 400 may include a plurality of tubes 410. Each of the bundled tube fuel nozzles 400 and the bluff body 100 may extend through a cap plate 44 that defines the forward end 72 of the combustion chamber 70. The downstream plate 104 of the bluff body 100 may define a plurality of outlets 124 arranged (either randomly or in a pattern) on the downstream plate 104. The bundled tube fuel nozzles 400 may be wedge shaped, such that the body 408 includes a first arcuate end wall 412, a second arcuate end wall 414, and two straight side walls 416 extending between the first arcuate end wall 412 and the second arcuate end wall 414. In other embodiments (not shown), the bundled tube fuel nozzles 400 may be circularly shaped (such that the body 408 is annular).

Referring now to FIG. 6, a cross-sectional view of the combustor 17 shown in FIG. 4 from along the line 6-6 is illustrated in accordance with embodiments of the present disclosure. As shown, the combustor 17 may include a plurality of swirler nozzles 300 that are positioned about, and that collectively surround, the bluff body 100. As discussed above, each of the swirler nozzles 300 may include an outer tube 302, a center body 304, and a plurality of vanes 306 extending between the outer tube 302 and the center body 304. Each of the swirler nozzles 300 and the bluff body 100 may extend through a cap plate 44 that defines the forward end 72 of the combustion chamber 70. The downstream plate 104 of the bluff body 100 may define a plurality of outlets 124 arranged (either randomly or in a pattern) on the downstream plate 104.

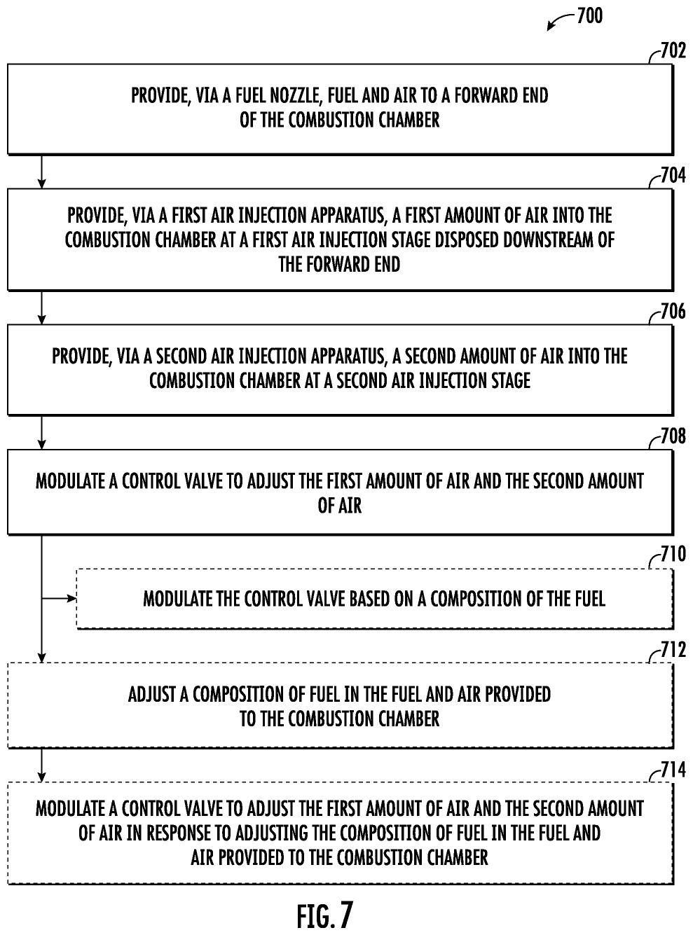

Referring now to FIG. 7, a flow diagram of one embodiment of a method 700 of operating a combustor on alternative fuels is illustrated in accordance with embodiments of the present subject matter. In general, the method 700 will be described herein with reference to the combustor 17 described above with reference to FIGS. 1-4. However, it will be appreciated by those of ordinary skill in the art that the disclosed method 700 may generally be utilized with any suitable combustor and/or may be utilized in connection with a system having any other suitable system configuration. In addition, although FIG. 7 depicts steps performed in a particular order for purposes of illustration and discussion, the methods discussed herein are not limited to any particular order or arrangement unless otherwise specified in the claims. One skilled in the art, using the disclosures provided herein, will appreciate that various steps of the methods disclosed herein can be omitted, rearranged, combined, and/or adapted in various ways without deviating from the scope of the present disclosure.

As used herein, “alternative fuels” may refer to fuel that is not conventionally used in a gas turbine combustor, such as natural gas (e.g., methane). Rather, “alternative fuels” may encompass fuels such as hydrogen and/or ammonia (or a combination or mixture of ammonia and hydrogen). The combustor of the method 700 may include a combustion chamber that extends between a forward end and an aft end.

In many implementations, the method 700 may include an initial step 702 of providing, via a fuel nozzle, fuel and air to a forward end of the combustion chamber. In many embodiments, the fuel may be the alternative fuel discussed above (such as ammonia, hydrogen, or a mixture of ammonia and hydrogen). The fuel may be provided by a fuel supply system to the fuel nozzle, and the air may be supplied to the fuel nozzle from an air supply (which may be the same or different than the air supply for the first air injection apparatus and the second air injection apparatus). The fuel supply system may include one or more valves, storage tanks, and/or pumps each in communication with a controller, such that the controller is operable to set a fuel composition provided to the fuel nozzles (e.g., entirely ammonia, ammonia mixed with hydrogen, etc.). Additionally, the fuel supply system may be operable to supply a mixture containing various amounts of each fuel in a mixture, such as (in one non-limiting example) a fuel mixture containing about 0%-30% hydrogen with about 70%-100% ammonia.

The fuel and air may be provided (e.g., injected) by the fuel nozzles at the forwardmost end of the combustion chamber, such that the fuel and air travel together, and undergo combustion (thereby becoming combustion gases) between the forward end and the aft end of the combustion chamber. Although the exemplary fuel nozzles 40 described above (i.e., bundled tube fuel nozzles 400 and swirler nozzles 300) introduce a fuel/air mixture into the combustion zone, it should be understood that the fuel and air may be directly injected by alternate fuel nozzles (not shown) through the cap assembly 44 and may be mixed in the combustion zone.

In exemplary embodiments, the method 700 may include, at step 704, providing, via a first air injection apparatus, a first amount of air into the combustion chamber at a first air injection stage disposed downstream of the forward end. The first air injection stage may be disposed axially aft of the location where the fuel/air are provided to the combustion chamber, such that the fuel/air injected by the nozzles have time to develop a flame and/or combust prior to the first air injection stage. Additionally, as discussed above, the first air injection apparatus may be a bluff body that extends at least partially within the combustion chamber, such that the air traveling through the bluff body is preheated prior to injection at the first air injection stage. In various implementations, the first air injection stage may be an axial injection, such that the first amount of air is introduced axially into the combustion chamber. Alternately, the first amount of air may be introduced at an acute angle into the combustion chamber.

In various embodiments, the method 700 may include, at step 706, providing, via a second air injection apparatus, a second amount of air into the combustion chamber at a second air injection stage. In exemplary embodiments, the second air injection stage may be disposed downstream of the first air injection stage. That is, the second air injection stage may be axially spaced apart from the first air injection stage such that an axial gap is defined therebetween. The second amount of air provided by the second air injection apparatus may be different than the first amount of air provided by the first air injection apparatus. In some embodiments, as discussed above, the second air injection apparatus may be an air injector mounted to the combustion liner. In other embodiments, the second air injection apparatus may be a plurality of diffusion holes defined in the combustion liner. The second air injection stage may be radial injection, such that the air from the second air injection apparatus is introduced radially into the combustion chamber.

In optional implementations (as indicated by the dashed boxes in FIG. 7), the method 700 may include, at step 708, modulating a control valve to adjust the first amount of air and the second amount of air. The control valve may be fluidly coupled to an air supply, the first air injection apparatus, and the second air injection apparatus. The control valve may be selectively actuatable between a fully open position, in which the flow of air therethrough is unrestricted, and a fully closed position, in which the flow of air therethrough is fully restricted. In addition, the control valve(s) may be actuatable to any position between the fully open and fully closed positions, such as anywhere between 0% and 100% restricted. In this way, modulating the control valve may adjust the first amount of air introduced at the first air injection stage and the second amount of air injected at the second air injection stage.

In various implementations, as shown by optional step 710, the method 700 may further include modulating the control valve based on a composition of the fuel. For example, the first amount and the second amount of air provided to the respective first and second air injection apparatus may be adjusted by modulating the control valve based on a composition of the fuel. In many implementations, as shown by optional step 712, the method 700 may include adjusting a composition of the fuel in the fuel and air provided to the combustion chamber. In such implementations, the method 700 may include, at step 714, modulating the control valve to adjust the first amount of air and the second amount of air in response to adjusting the composition of fuel in the fuel and air provided to the combustion chamber.

For example, if the fuel initially contains entirely ammonia, then the control valve may be set to a first position. If the fuel composition is subsequently adjusted (such that the fuel now contains a majority of ammonia and a remainder of hydrogen), then the control valve may be modulated to a second position different than the first position. In various implementations, in a first operational mode, the fuel in the fuel and air provided to the combustion chamber may contain less than about 20% hydrogen (or such as less than 10%, or such as less than 5%) and with a fuel remainder being ammonia.

A sum of the first amount of air and the second amount of air may be referred to as “total staging air.” In the first operational mode, the method may include providing, via the first air injection apparatus, the first amount of air that is between about 0% and about 10% of the total staging air (or such as between about 0% and about 5% of the total staging air, or such as between about 5% and about 10% of the total staging air). Additionally, or subsequently, the method may include providing, via the second air injection apparatus, the second amount of air that is an air remainder of the total staging air.

In the first operational mode, an equivalence ratio of products within the combustor may be between about 1 and about 1.5 upstream of the first air injection stage, which may be the optimal range when operating on less than 20% hydrogen with a remainder of ammonia.

In a second operational mode (which is different than the first operational mode), the fuel in the fuel and air provided to the combustion chamber may contain between about 20% and about 30% hydrogen and with a fuel remainder being ammonia. In such operational modes, the method may further include providing, via the first air injection apparatus, the first amount of air that is between about 20% and about 50% of the total staging air (or such as between about 30% and about 40% of the total staging air). Additionally, or subsequently, the method may include providing, via the second air injection apparatus, the second amount of air that is an air remainder of the total staging air to the second injection stage.

In the second operational mode, an equivalence ratio of products within the combustor may be between about 1 and about 1.5 upstream of the second air injection stage which may be the optimal range when operating on between about 20%-30% hydrogen with a remainder of ammonia.

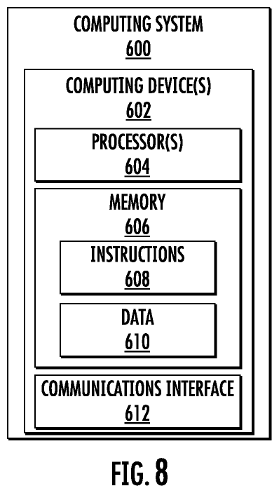

FIG. 8 provides a block diagram of an example computing system 600. The computing system 600 can be used to implement the aspects disclosed herein. The computing system 600 can include one or more computing device(s) 602. The controller 200 described above with reference to FIGS. 2-4 may be constructed and may operate in a same or similar manner as one of the computing devices 602, for example.

As shown in FIG. 8, the one or more computing device(s) 602 can each include one or more processor(s) 604 and one or more memory device(s) 606. The one or more processor(s) 604 can include any suitable processing device, such as a microprocessor, microcontroller, integrated circuit, logic device, or other suitable processing device. The one or more memory device(s) 606 can include one or more computer-readable media, including, but not limited to, non-transitory computer-readable medium or media, RAM, ROM, hard drives, flash drives, and other memory devices, such as one or more buffer devices.

The one or more memory device(s) 606 can store information accessible by the one or more processor(s) 604, including computer-readable or computer-executable instructions 608 that can be executed by the one or more processor(s) 604. The instructions 608 can be any set of instructions or control logic that when executed by the one or more processor(s) 604, cause the one or more processor(s) 604 to perform operations. The instructions 608 can be software written in any suitable programming language or can be implemented in hardware.

The memory device(s) 606 can further store data 610 that can be accessed by the processor(s) 604. For example, the data 610 can include sensor data (such as engine parameters), model data, logic data, etc., as described herein. The data 610 can include one or more table(s), function(s), algorithm(s), model(s), equation(s), etc. according to example embodiments of the present disclosure.

The one or more computing device(s) 602 can also include a communication interface 612 used to communicate, for example, with the other components of the gas turbine engine. The communication interface 612 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A combustor comprising: a combustion liner defining a combustion chamber that extends from a forward end to an aft end; a fuel nozzle disposed at a forward end of the combustion chamber; a first air injection apparatus disposed at a first air injection stage and fluidly coupled to an air supply, the first air injection stage positioned downstream of the fuel nozzle, wherein the first air injection apparatus comprises a bluff body having a side wall and a downstream plate, the first air injection apparatus configured to introduce air at a downstream end into the combustion chamber at the first air injection stage; and a second air injection apparatus disposed at a second air injection stage and fluidly coupled to the air supply, the second air injection stage positioned downstream of the fuel nozzle and the first air injection stage.

The combustor as in any preceding clause, further comprising a control valve fluidly coupled to the first air injection apparatus, the air second air injection apparatus, and the air supply, the control valve configured to modulate an amount of air provided to the combustion chamber from the air supply at the first air injection stage and the second air injection stage.

The combustor as in any preceding clause, wherein the bluff body extends along an axial centerline of the combustor into the combustion chamber.

The combustor as in any preceding clause, wherein the second air injection apparatus is an air injector coupled to the combustion liner and configured to introduce air radially into the combustion chamber at the second air injection stage.

The combustor as in any preceding clause, wherein the fuel nozzle is a first fuel nozzle in a plurality of fuel nozzles, and wherein the plurality of fuel nozzles surrounds the first air injection apparatus.

The combustor as in any preceding clause, wherein the fuel nozzle is a bundled tube fuel nozzle defining a fuel plenum with a forward plate, an aft plate, an annular body extending between the forward plate and the aft plate, and a plurality of tubes extending from the forward plate through the fuel plenum to the aft plate.

The combustor as in any preceding clause, wherein the fuel nozzle is a swirler nozzle having an outer tube, a center body, and vanes extending between the center body and the outer tube.

The combustor as in any preceding clause, wherein the fuel nozzle is fluidly coupled to a fuel supply system.

The combustor as in any preceding clause, wherein the fuel supply system includes at least one of an ammonia supply and a hydrogen supply.

A method of operating a combustor on alternative fuels, the combustor comprising a combustion liner that defines a combustion chamber extending between a forward end and an aft end, the method comprising: providing, via a fuel nozzle, fuel and air to a forward end of the combustion chamber; providing, via a first air injection apparatus, a first amount of air into the combustion chamber at a first air injection stage disposed downstream of the forward end; providing, via a second air injection apparatus, a second amount of air into the combustion chamber at a second air injection stage, the second air injection stage disposed downstream of the first air injection stage; and modulating a control valve to adjust the first amount of air and the second amount of air.

The method as in any preceding clause, further comprising: adjusting the first amount of air and the second amount of air by modulating the control valve based on a composition of the fuel.

The method as in any preceding clause, further comprising: adjusting a composition of fuel in the fuel and air provided to the combustion chamber;
modulating the control valve to adjust the first amount of air and the second amount of air in response to adjusting the composition of fuel in the fuel and air provided to the combustion chamber.

The method as in any preceding clause, wherein, in a first operational mode, the fuel in the fuel and air provided to the combustion chamber contains less than about 20% hydrogen and with a fuel remainder being ammonia, wherein a sum of the first amount of air and the second amount of air is a total staging air, and wherein the method comprises: providing, via the first air injection apparatus, the first amount of air that is between about 0% and about 10% of the total staging air; and providing, via the second air injection apparatus, the second amount of air that is an air remainder of the total staging air.

The method as in any preceding clause, wherein, in the first operational mode, an equivalence ratio of products within the combustor is between about 1 and about 1.5 upstream of the first air injection stage.

The method as in any preceding clause, wherein, in a second operational mode, the fuel in fuel and air provided to the combustion chamber contains between about 20% and about 30% hydrogen and with a fuel remainder being ammonia, wherein a sum of the first amount of air and the second amount of air is a total staging air, and wherein the method comprises: providing, via the first air injection apparatus, the first amount of air that is between about 20% and about 50% of the total staging air; and providing, via the second air injection apparatus, the second amount of air that is an air remainder of the total staging air.

The method as in any preceding clause, wherein, in the second operational mode, an equivalence ratio of products within the combustor is between about 1 and about 1.5 upstream of the second air injection stage.

The method as in any preceding clause, wherein the first air injection apparatus comprises a bluff body having an side wall and a downstream plate, wherein at least one of the side wall and the downstream plate is configured to introduce air into the combustion chamber at the first air injection stage.

The method as in any preceding clause, wherein the second air injection apparatus is an air injector coupled to the combustion liner and configured to introduce air radially into the combustion chamber at the second air injection stage.

A combustor comprising: a combustion liner defining a combustion chamber that extends from a forward end to an aft end; a fuel nozzle disposed at a forward end of the combustion chamber; a first air injection apparatus disposed at a first air injection stage and fluidly coupled to an air supply, the first air injection stage positioned downstream of the fuel nozzle; a second air injection apparatus disposed at a second air injection stage and fluidly coupled to the air supply, the second air injection stage positioned downstream of the fuel nozzle and the first air injection stage; and a control valve fluidly coupled to the first air injection apparatus, the air second air injection apparatus, and the air supply, the control valve configured to modulate an amount of air provided to the combustion chamber from the air supply at the first air injection stage and the second air injection stage.

The combustor as in any preceding clause, wherein the first air injection apparatus is disposed at the forward end of the combustion chamber and is fluidly coupled to the air supply, wherein the first air injection apparatus defines a first air injection stage positioned downstream of the fuel nozzle.

1. A combustor comprising:
a combustion liner defining a combustion chamber that extends from a forward end to an aft end;
a fuel nozzle disposed at a forward end of the combustion chamber, the fuel nozzle configured to convey fuel and compressed air into the combustion chamber;
a first air injection apparatus disposed at a first air injection stage and fluidly coupled to an air supply, the first air injection stage positioned downstream of the fuel nozzle, wherein the first air injection apparatus comprises a bluff body having a side wall and a downstream plate, the first air injection apparatus configured to introduce air at a downstream end into the combustion chamber at the first air injection stage; and
a second air injection apparatus disposed at a second air injection stage and fluidly coupled to the air supply, the second air injection stage positioned downstream of the fuel nozzle and the first air injection stage.

2. The combustor as in claim 1, further comprising a control valve fluidly coupled to the first air injection apparatus, the second air injection apparatus, and the air supply, the control valve configured to modulate an amount of air provided to the combustion chamber from the air supply at the first air injection stage and the second air injection stage.

3. The combustor as in claim 1, wherein the bluff body extends along an axial centerline of the combustor into the combustion chamber.

4. The combustor as in claim 1, wherein the second air injection apparatus is an air injector coupled to the combustion liner and configured to introduce air radially into the combustion chamber at the second air injection stage.

5. The combustor as in claim 1, wherein the fuel nozzle is a first fuel nozzle in a plurality of fuel nozzles, and wherein the plurality of fuel nozzles surrounds the first air injection apparatus.

6. The combustor as in claim 1, wherein the fuel nozzle is a bundled tube fuel nozzle defining a fuel plenum with a forward plate, an aft plate, an annular body extending between the forward plate and the aft plate, and a plurality of tubes extending from the forward plate through the fuel plenum to the aft plate.

7. The combustor as in claim 1, wherein the fuel nozzle is a swirler nozzle having an outer tube, a center body, and vanes extending between the center body and the outer tube.

8. The combustor as in claim 1, wherein the fuel nozzle is fluidly coupled to a fuel supply system.

9. The combustor as in claim 8, wherein the fuel supply system includes at least one of an ammonia supply and a hydrogen supply.

10. A method of operating a combustor on alternative fuels, the combustor comprising a combustion liner that defines a combustion chamber extending between a forward end and an aft end, the method comprising:
providing, via a fuel nozzle, fuel and air to a forward end of the combustion chamber;
providing, via a first air injection apparatus, a first amount of air into the combustion chamber at a first air injection stage disposed downstream of the forward end;
providing, via a second air injection apparatus, a second amount of air into the combustion chamber at a second air injection stage, the second air injection stage disposed downstream of the first air injection stage; and
modulating a control valve to a first position to adjust the first amount of air and the second amount of air based on a first composition of the fuel;
adjusting a composition of fuel from the first composition to a second composition; and
modulating the control valve to a second position to adjust the first amount of air and the second amount of air in response to adjusting to the second composition of fuel.

11. (canceled)

12. (canceled)

13. The method as in claim 10, wherein, in a first operational mode, the fuel in the fuel and air provided to the combustion chamber contains less than 20% hydrogen and with a fuel remainder being ammonia, wherein a sum of the first amount of air and the second amount of air is a total staging air, and wherein the method comprises:
providing, via the first air injection apparatus, the first amount of air that is between 0% and 10% of the total staging air; and
providing, via the second air injection apparatus, the second amount of air that is an air remainder of the total staging air.

14. The method as in claim 13, wherein, in the first operational mode, an equivalence ratio of products within the combustor is between 1 and 1.5 upstream of the first air injection stage.

15. The method as in claim 10, wherein, in a second operational mode, the fuel in fuel and air provided to the combustion chamber contains between 20% and 30% hydrogen and with a fuel remainder being ammonia, wherein a sum of the first amount of air and the second amount of air is a total staging air, and wherein the method comprises:
providing, via the first air injection apparatus, the first amount of air that is between 20% and 50% of the total staging air; and
providing, via the second air injection apparatus, the second amount of air that is an air remainder of the total staging air.

16. The method as in claim 15, wherein, in the second operational mode, an equivalence ratio of products within the combustor is between 1 and 1.5 upstream of the second air injection stage.

17. The method as in claim 10, wherein the first air injection apparatus comprises a bluff body having a solid side wall and a downstream plate, wherein the downstream plate is configured to introduce air into the combustion chamber at the first air injection stage.

18. The method as in claim 10, wherein the second air injection apparatus is an air injector coupled to the combustion liner and configured to introduce air radially into the combustion chamber at the second air injection stage.

19. A combustor comprising:
a combustion liner defining a combustion chamber that extends from a forward end to an aft end;
a fuel nozzle disposed at a forward end of the combustion chamber;
a first air injection apparatus disposed at a first air injection stage and fluidly coupled to an air supply, the first air injection stage positioned downstream of the fuel nozzle;
a second air injection apparatus disposed at a second air injection stage and fluidly coupled to the air supply, the second air injection stage positioned downstream of the fuel nozzle and the first air injection stage; and
a control valve fluidly coupled to the first air injection apparatus, the second air injection apparatus, and the air supply, the control valve configured to modulate an amount of air provided to the combustion chamber from the air supply at both the first air injection stage and the second air injection stage.

20. The combustor as in claim 1, wherein the side wall is solid.
